(19) United States
(12) Patent Application Publication
(10) Pub. No.: US 2015/0267622 A1
(43) Pub. Date: Sep. 24, 2015

(54) THROTTLE VALVE FOR AN INTERNAL COMBUSTION ENGINE PROVIDED WITH A CONDITIONING CIRCUIT

(71) Applicant: Magneti Marelli S.p.A., Corbetta (IT)

(72) Inventors: Stefano Musolesi, Bologna (IT); Marcello Colli, Reggio Emilia (IT); Francesco Toschi, Bologna (IT)

(21) Appl. No.: 14/661,208

(22) Filed: Mar. 18, 2015

(30) Foreign Application Priority Data
Mar. 19, 2014 (IT) BO2014A000140

(51) Int. Cl. F02D 9/10

(52) U.S. Cl. CPC F02D 9/1085; F02D 9/1005; F02D 9/1035

(57) ABSTRACT

A throttle valve for an internal combustion engine. The throttle valve includes a valve body, a tubular feeding duct defined in the valve body, and an actuating device which controls rotation of a throttle plate around a rotation axis via an electric motor. An actuating device conditioning circuit is defined in the valve body. The valve body is entirely made of a first metal material. The circuit has a conditioning pipe made of a second metal material. The valve body is injection-overmoulded around the pipe.

### CROSS-REFERENCE TO RELATED APPLICATION

This application is based upon and claims priority to Italian Patent Application No. BO2014A000140, filed on Mar. 19, 2014.

### BACKGROUND OF THE INVENTION

1. Field of the Invention

The present invention relates to a throttle valve for an internal combustion engine provided with a conditioning circuit.

2. Description of the Related Art

Throttle valves used with internal combustion engines are well known in the related art. Typically, the throttle valve is arranged upstream of an intake manifold and adjusts the air flow rate fed to the engine cylinders. Conventional throttle valves include a valve body provided with a tubular feeding duct through which air taken in (or, compressed) for the internal combustion engine flows. A throttle plate is housed inside the feeding duct and may be splined to a rotatable shaft so as to rotate between an opening position and a closing position of the feeding duct. The rotation of the throttle plate may be controlled by an actuating device, which typically includes an electric motor coupled to the throttle plate shaft via a gear drive and at least one spring that pushes the throttle plate shaft towards the closing position (or towards a limp-home position preceding the closing position). The electric motor may have a cylindrical body arranged in a tubular housing of the valve body next to the feeding duct. The gear drive may be arranged in a chamber of the valve body defined by two shells. The first shell may be realized as a removable lid, and a second shell may be arranged next to the feeding duct and next to the tubular housing.

The valve body may include a conditioning circuit defined by a channel. The channel can take various forms and paths. The channel may be substantially L-shaped with: a major branch, which is obtained in an upper portion of the second shell; and a minor branch, which is obtained in an upper portion of the tubular housing. The channel is in hydraulic communication with a pump that circulates conditioning fluid and feeds the conditioning fluid to the channel for conditioning different parts of the throttle valve.

In most conventional throttle valves, the entire valve body is typically made of metal material, such as aluminum, and is monolithic (such as a single, seamless piece). The valve body (for example: the second shell, the feeding pipe, and the tubular housing) may be manufactured via fusion (normally die cast) and may be subsequently mechanically processed. In producing the valve body via fusion (normally die cast), injection of the material occurs at relatively high temperatures (of the order of 700° C.) and high pressures (of the order of 1000 bar) which, in some instances, may result in porosities and/or micro-bubbles of air occurring in the valve body that are hardly visible to the naked eye (and may only be visible with X-rays) and that are difficult to identify when setting and/or adjusting the throttle valve.

The porosity and/or micro-bubbles are particularly dangerous because the valve body, over time and in case of relatively high pressures involved, the passage of the conditioning fluid in the channel of the conditioning circuit can erode material between different micro-bubbles and create paths for conditioning fluid to other components of the valve body; in particular, towards the electric motor, to the feeding duct, or to the external environment.

### SUMMARY OF THE INVENTION

The present invention is directed toward a throttle valve for an internal combustion engine. The throttle valve includes a valve body, a tubular feeding duct, and a throttle plate. The tubular feeding duct is defined in the valve body. Air taken in by the internal combustion engine flows through the feeding duct. The throttle plate is arranged inside the feeding duct and is splined to a rotatably mounted shaft so as to rotate around a rotation axis between a maximum opening position and a closing position to open and close the feeding duct. An actuating device controls rotation of the throttle plate around the rotation axis and includes an electric motor and a gear drive. The gear drive transmits motion from the electric motor to the shaft of the throttle plate. An actuating device conditioning circuit is defined in the valve body. The valve body is entirely made of a first metal material. The conditioning circuit includes a pipe made of a second metal material. The valve body is injection-overmoulded around the pipe.

In this way, throttle valve of the present invention overcomes the disadvantages in the related art state of the art and, at the same time, is easy and inexpensive to manufacture.

### BRIEF DESCRIPTION OF THE DRAWINGS

Other objects, features, and advantages of the present invention will be readily appreciated as the same becomes better understood after reading the subsequent description taken in connection with the accompanying drawings wherein:

FIG. 1 is a partially-exploded perspective view of parts of a throttle valve according to one embodiment of the present invention.

FIG. 2 is a front view of parts of the throttle valve of FIG. 1.

FIG. 3 is a perspective view of a portion of the throttle valve of FIG. 1 showing a conditioning circuit.

FIG. 4 is a plan view of parts of the throttle valve of FIG. 1.

FIG. 5 is a perspective view of the conditioning circuit of FIG. 3 showing a channel and a pipe.

FIG. 6A is a perspective view of the channel of FIG. 5.

FIG. 6B is a perspective view of the pipe of FIG. 5.

### DETAILED DESCRIPTION OF THE INVENTION

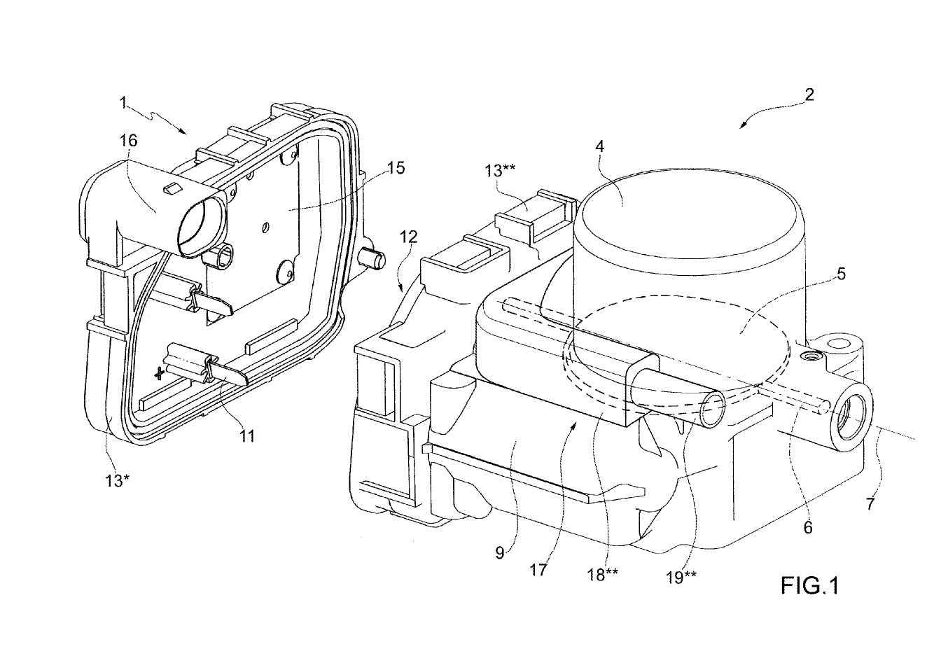

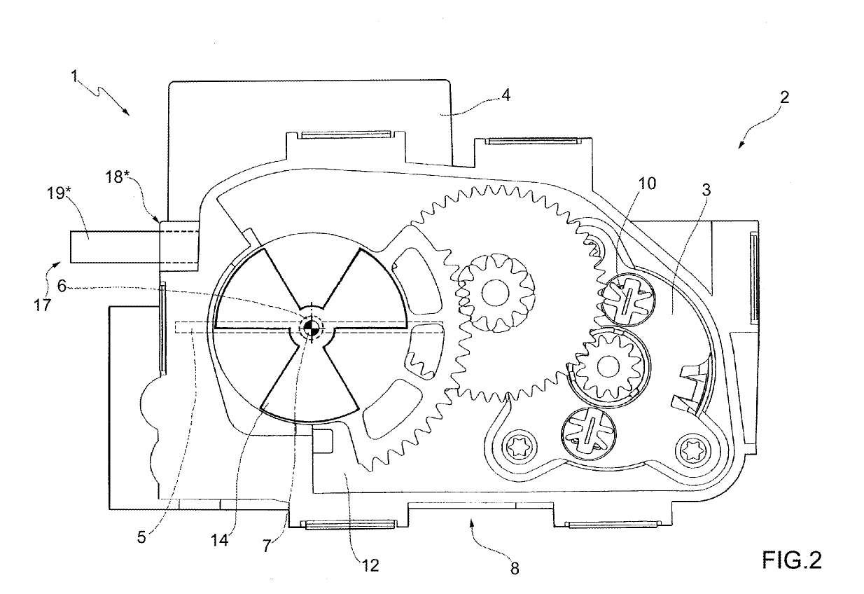

With reference now to the drawings, a throttle valve with electric control is generally indicated at 1 in FIGS. 1 and 2. The throttle valve 1 is for an internal combustion engine (not shown, but generally known in the art) and includes: a valve body 2 housing an electric motor 3 (see FIG. 2); a tubular feeding duct 4 with circular section through which air taken in by the internal combustion engine flows; and a throttle plate 5 (shown schematically in dashed lines) which has a circular shape, engages the feeding duct 4, and rotates between an opening position and a closing position of the feeding duct 4 due to action of an actuating device. The throttle plate 5 is splined to a shaft 6 having a longitudinal rotation axis 7 to rotate between the opening position and the closing position due to the action of the actuating device.

As illustrated in FIG. 2, the actuating device includes the electric motor 3 coupled to the shaft 6 via a gear drive 8. The actuating device may also include a return spring coupled to the shaft 6 configured to rotate the throttle plate 5 towards the closing position, and a contrast spring coupled to the shaft 6 configured to rotate the throttle plate 5 towards a limp-home position defined by an abutment body against the action of the return spring.

The electric motor 3 has a cylindrical body arranged in a tubular housing 9 (see FIG. 1) of the valve body 2 next to the feeding duct 4 and is maintained in a predetermined position inside the tubular housing 9 by a metal plate provided with a pair of female electric connectors 10 (see FIG. 2), which are electrically connected to the electric motor 3 and are configured to be engaged by a pair of respective male electric connectors 11 (see FIG. 1).

The gear drive 8 is arranged in a chamber 12 (see FIG. 2) of the valve body 2, which is defined by two shells 13* and 13**. Here, the first shell is realized as a removable lid 13* (see FIG. 1) and the second shell 13** is arranged next to the feeding duct 4 and next to the tubular housing 9.

As shown in FIGS. 1 and 2, the throttle valve 1 includes a “contactless” inductive position sensor coupled to the shaft 6 and configured to detect the angular position of the shaft 6 and, thus, of the throttle plate 5 in order to allow feedback control of the position of the throttle plate 5. The position sensor includes a rotor 14 (see FIG. 2) integral with the shaft 6, and a stator 15 arranged facing the rotor 14 (see FIG. 1) and carried by the removable lid 13*.

As shown in FIG. 1, the removable lid 13* is provided with a female electric connector 16, which includes a series of electric contacts (not shown in detail): two electric contacts are connected to the male electric connectors 11 configured to feed the electric motor 3, while other electric contacts are attached to the stator 15 of the position sensor.

The valve body 2 is entirely made of a first material and internally defines the feeding duct 4. The valve body 2 includes the tubular housing 9 arranged next to the feeding duct 4, and houses the electric motor 3 and the chamber 12. The chamber 12 houses the gear drive 8 and is closed by the removable lid 13*. In other words, the shell 13**, the feeding duct 4, and the tubular housing 9 are made of the first material.

In one embodiment, the material that makes up the valve body 2 (for example, the shell 13**, the feeding duct 4, and the tubular housing 9) is a metal material, in particular aluminum. Advantageously, the throttle plate 5 is made with the same first metal material forming the valve body 2. Alternatively, the throttle plate 5 may be made of a metal material that is different from the first metal material which forms the valve body 2 but still has a behavior similar to the first metal material forming the valve body 2. In this way, the two parts which cooperate to define the closure of the feeding duct 4 are made with the same material (or both metal materials similar to each other) and therefore allow substantially the same type of performance regarding both temperature variations and deterioration over time in use.

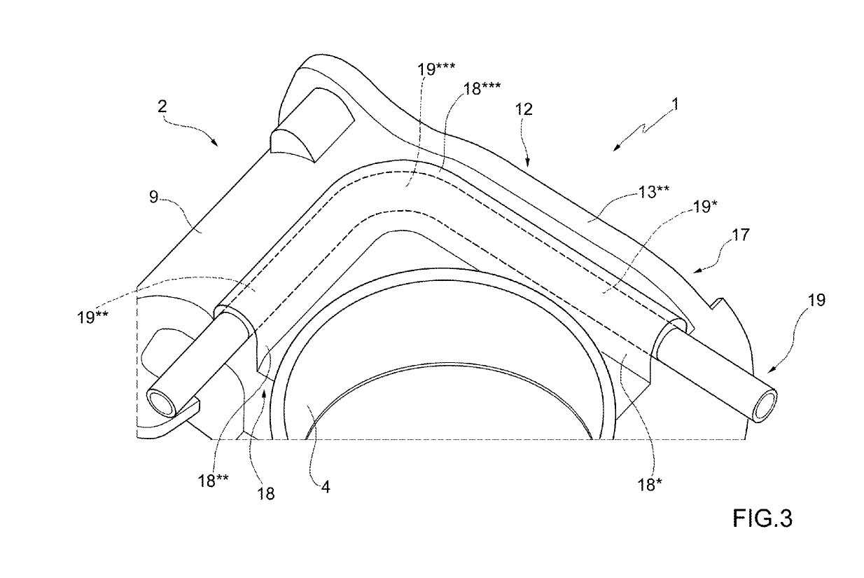

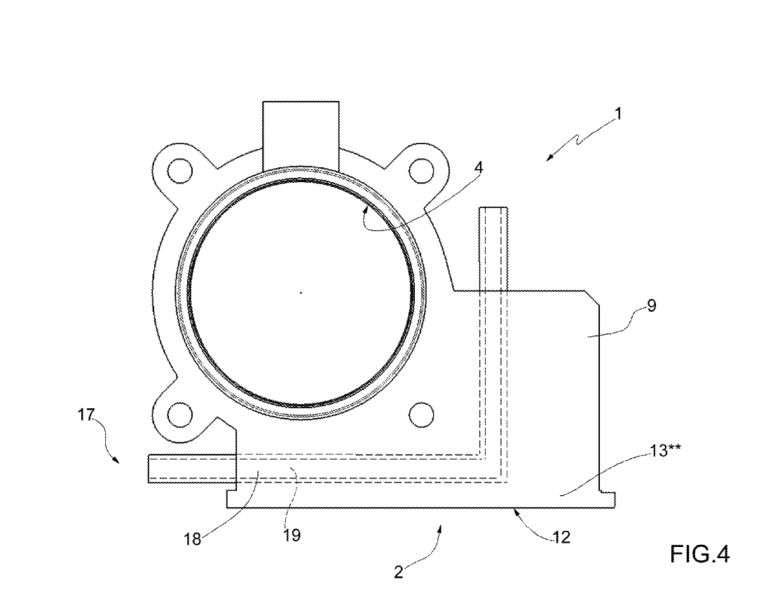

In the embodiment illustrated in FIGS. 3 and 4, the valve body 2 includes a conditioning circuit 17 which, in turn, includes a channel 18 and a pipe 19. The channel 18 is substantially L-shaped and has a major branch 18* obtained in an upper portion of the shell 13**, a minor branch 18** obtained in an upper portion of the tubular housing 9, and a bent joint segment 18*** between the major branch 18* and the minor branch 18**. The pipe 19 is housed inside the channel 18. The pipe 19 is made of a second material and is also substantially L-shaped having a major branch 19*, a minor branch 19 **, and a bent joint segment 19 *** between the major branch and the minor branch. In one embodiment, the second material which makes up the pipe 19 is steel, such as stainless steel. The pipe 19 is in hydraulic communication with a pump (not shown, but generally known in the art) that circulates conditioning fluid and feeds conditioning fluid to the channel for conditioning different parts of the throttle valve.

The valve body 2 (for example, the shell 13**, the feeding duct 4, and the tubular housing 9) is made by fusion (normally die cast) with the pipe 19 inserted inside a mold (as described in greater detail below) and, in some circumstances, is subsequently machined. In other words, the first material forming the valve body 2 (for example, the shell 13**, the feeding duct 4, and the tubular housing 9) is injection molded around the pipe 19 so that an outer surface of the pipe 19 is arranged in contact with an inner surface of the channel 18.

In one embodiment, an abutment support element is housed inside the mold used for the production of the valve body 2 (for example, the shell 13**, the feeding duct 4, and the tubular housing 9) via fusion (normally die cast). During injection, the support element acts as an abutment and as a support for the pipe 19 to prevent movement of the pipe 19.

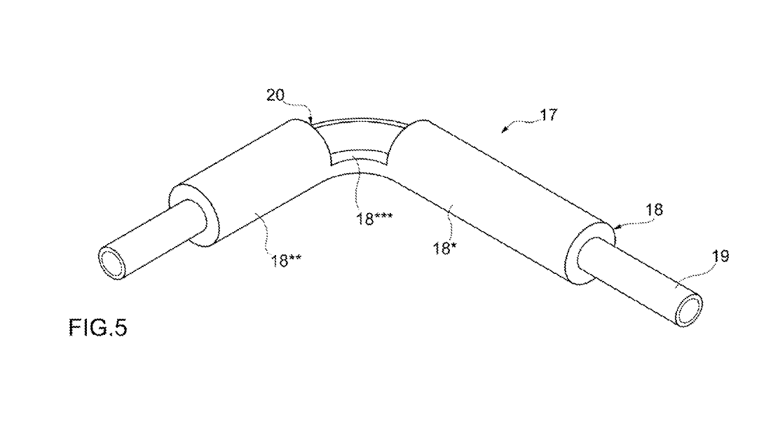

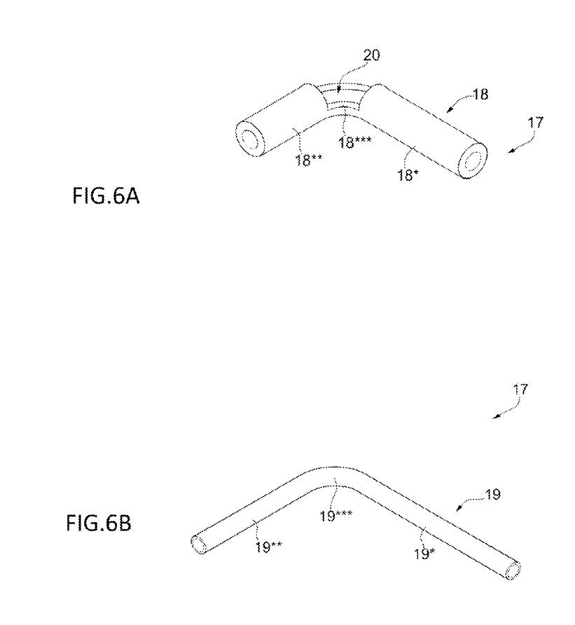

As illustrated in detail in FIGS. 5, 6A, and 6B, the support element may be arranged inside the mold at the bent joint segment 19*** of the pipe 19. The channel 18 is substantially L-shaped and has the major branch 18*, which is obtained in the upper portion of the shell 13**, the minor branch 18**, which is obtained in the upper portion of the tubular housing 9 and the bent joint segment 18*** between the major branch 18* and the minor branch 18** and open on the upper part. In one embodiment, the bent joint segment 18*** has a top window 20 the shape of which is complementary to the shape of the bearing element arranged inside the mold.

It will be appreciated that the conditioning circuit 17 may alternately be configured with different shapes other than the substantially L shape as described above. In particular, according to different alternatives, the conditioning circuit 17 (for example, the channel 18 and the pipe 19) may have a rectilinear shape and may be obtained in the upper portion of the shell 13** or in the upper portion of the tubular housing 9.

In this way, the throttle valve 1 of the present invention is easy and inexpensive to manufacture. In particular, it will be appreciated that the valve body 2 of the throttle valve 1 can manufactured with ease and at low cost by injection overmoulding the valve body 2 (for example, the shell 13**, the feeding duct 4, and the tubular housing 9) around the pipe 19. Moreover, it will be appreciated that the valve body 2 of the throttle valve 1 has extremely reasonable weight and manufacturing cost. Further, the throttle valve 1 facilitates prevention of passage of conditioning fluid used in the conditioning circuit and contained inside the pipe 19 towards, for example, the electric motor 3, the feeding duct 4, or towards the external environment during use, regardless of use over time.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A throttle valve for an internal combustion engine, the throttle valve comprising:
a valve body;
a tubular feeding duct defined in the valve body through which air taken in by the internal combustion engine flows; and
a throttle plate arranged inside the feeding duct and splined to a shaft mounted in a rotary manner, so as to rotate around a rotation axis between a maximum opening position and a closing position to open and close the feeding duct;
an actuating device including an electric motor and a gear drive, which transmits motion from the electric motor to the shaft of the throttle plate, so as to control rotation of the throttle plate around the rotation axis;
an actuating device conditioning circuit defined in the valve body;
wherein the valve body is entirely made of a first metal material and the conditioning circuit includes a pipe made of a second metal material, and wherein the valve body is injection-overmoulded around the pipe.

2. The throttle valve as set forth in claim 1, wherein the second metal material is steel.

3. The throttle valve as set forth in claim 1, wherein the first metal material is aluminum.

4. The throttle valve as set forth in claim 1, wherein the throttle plate is made of the same first material that makes up the valve body.

5. The throttle valve as set forth in claim 1, wherein the valve body includes a tubular housing, which is arranged next to the feeding duct and houses the electric motor; and wherein the gear drive is arranged in a chamber of the valve body, which is defined by: a removable lid first shell, and a second shell arranged next to the feeding duct and next to the tubular housing.

6. The throttle valve as set forth in claim 5, wherein the pipe includes a first branch housed in an upper portion of the second shell.

7. The throttle valve as set forth in claim 5, wherein the pipe includes a second branch housed in an upper portion of the tubular housing.

8. The throttle valve as set forth in claim 6, wherein the pipe is substantially L-shaped and includes a second branch housed in an upper portion of the tubular housing.

9. The throttle valve as set forth in claim 8, wherein the pipe includes a joint segment joining the first branch housed in the upper portion of the second shell to the second branch housed in the upper portion of the tubular housing.

10. The throttle valve as set forth in claim 9, wherein the conditioning circuit includes a channel in the valve body, made of the first metal material, and designed to house the pipe; and wherein the channel includes a first branch in the upper portion of the second shell, a second branch in the upper portion of the tubular housing, and a bent joint segment joining the first branch and the second branch together.

11. The throttle valve as set forth in claim 10, wherein the bent joint segment between the first branch and the second branch is open on the upper part.

12. The throttle valve as set forth in claim 1, wherein the second metal material is stainless steel.
